(19) United States
(12) Patent Application Publication
(10) Pub. No.: US 2006/0115232 A1
(43) Pub. Date: Jun. 1, 2006

(54) Reproducing apparatus, reproducing system, and reproducing method

(76) Inventors: Atsushi Hirota, Yokohama-shi (JP); Wataru Kuroiwa, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/288,121

(22) Filed: Nov. 29, 2005

(30) Foreign Application Priority Data
Nov. 30, 2004 (JP) 2004-347784

(51) Int. Cl. H04N 5/91

(52) U.S. Cl. 386/46

(57) ABSTRACT

A reproducing apparatus has a communication unit which receives distribution of contents from a server device via a network, a decoding unit, a reproducing unit, and a control unit which controls to when encrypting and distributing divided contents of the contents from plural modules owned by each of plural server units owned by the server device, distribute distribution information showing each one of the divided contents to be supplied from which one of plural module units in the plural server units, plural decoding keys depending on each module unit of each server unit, and plural divided contents individually encrypted by the plural decoding keys, from the server device via the communication unit, to decode the plural divided contents by the decoding unit on the basis of the distribution information and plural decoding keys, and to reproduce the decoded contents.

### CROSS-REFERENCE TO RELATED APPLICATIONS

This application is based upon and claims the benefit of priority from prior Japanese Patent Application No. 2004-347784, filed Nov. 30, 2004, the entire contents of which are incorporated herein by reference.

### BACKGROUND OF THE INVENTION

1. Field of the Invention

The present invention relates to a reproducing apparatus for receiving and reproducing contents from a distribution site, for example, through a network, and more particularly, to a reproducing apparatus and a reproducing system for receiving and reproducing divided and encrypted contents from plural servers of a distribution site.

2. Description of the Related Art

Recently, environments are prepared for distribution service such as video and music by high speed communications owing to spread of communication infrastructure such as an asymmetric digital subscriber line (ADSL) and optical communication. Access terminals to a communication network at home are basically personal computers (PCs), and recording and reproducing apparatuses having communication and connection functions are also developed.

Patent document 1 (Jpn. Pat. Appln. KOKAI Publication No. 2004-70712) discloses a server device capable of distributing contents from a server via a network.

In this prior art, however, sufficient security is not assured when distributing contents. For example, in a case where a decoding key is illegally obtained by some way even if distributed contents are encrypted, it is difficult to minimize the loss by illegal use by identification of an illegal user or the terminal, or distribution of a decoding key to the general public through the Internet or the like.

### BRIEF SUMMARY OF THE INVENTION

An embodiment according to the present invention is a reproducing apparatus comprising a communication unit 111 which receives distribution of contents from a server device T via a network, a decoding unit 144, a reproducing unit 123, and a control unit 130 which controls to: when encrypting and distributing divided contents of the contents from plural modules owned by each of plural server units S1 to Sn owned by the server device T, distribute distribution information 22, 23 showing each one of the divided contents to be supplied from which one of plural module units in the plural server units, plural decoding keys 24 depending on each module unit of each server unit, and plural divided contents 21 individually encrypted by the plural decoding keys, from the server device via the communication unit; to decode the plural divided contents by the decoding unit on the basis of the distribution information and plural decoding keys; and to reproduce the decoded contents.

### BRIEF DESCRIPTION OF THE SEVERAL VIEWS OF THE DRAWING

FIG. 1 is a block diagram showing an example of reproducing system according to an embodiment of the invention;

FIG. 2 is a block diagram showing an example of a configuration of a recording and reproducing apparatus according to the embodiment of the invention;

FIG. 3 shows correspondence of a server unit, a module units and plural decoding keys handled by the reproducing system according to the embodiment of the invention;

FIG. 4 shows relation among divided contents, a server unit, a module unit, and key information handled by the reproducing system according to the embodiment of the invention;

FIG. 5 shows another relation among the divided contents, server unit, module unit, and key information handled by the reproducing system according to the embodiment of the invention;

FIG. 6 is an explanatory diagram showing an outline of a communication process in the reproducing system according to the embodiment of the invention;

FIG. 7 is a flowchart explaining an example of a process of acquiring contents in the reproducing apparatus according to the embodiment of the invention;

FIG. 8 is a flowchart explaining an example of a process of reproducing contents in the reproducing apparatus according to the embodiment of the invention;

FIG. 9 is a diagram showing addresses of distribution servers to be accessed by the reproducing apparatus according to the embodiment of the invention;

FIG. 10 is an explanatory diagram showing an outline of a method of acquiring contents in the reproducing system according to another embodiment of the invention; and

FIG. 11 is an explanatory diagram showing an outline of a method of acquiring contents in the reproducing system according to another embodiment of the invention.

### DETAILED DESCRIPTION OF THE INVENTION

Embodiments of the invention will be specifically described below with reference to the accompanying drawings.

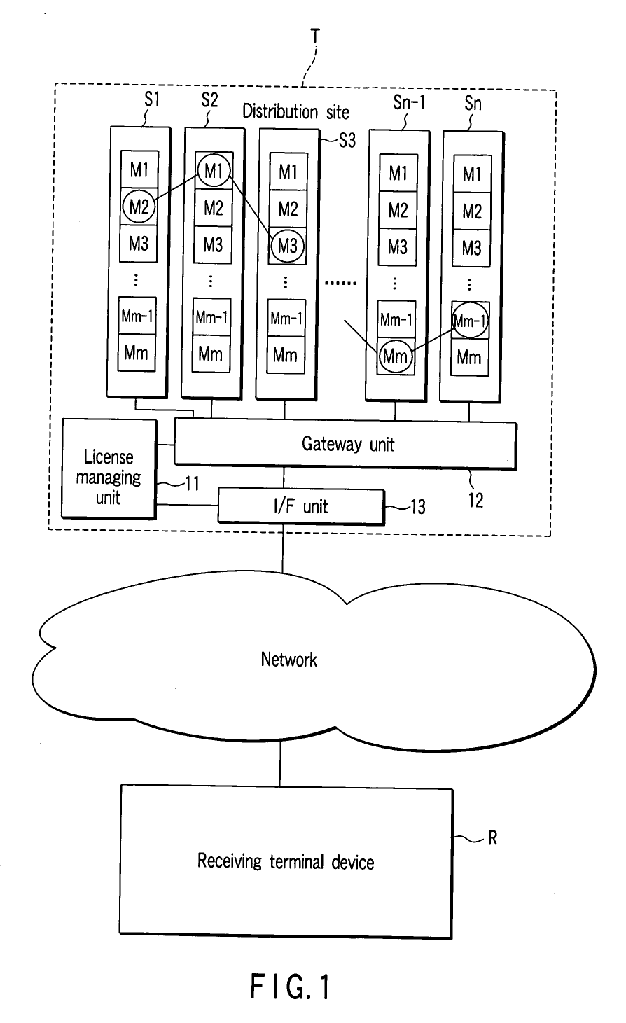

The invention relates to a reproducing apparatus for receiving and reproducing contents, for example, through a network, a server device for distributing contents, and a reproducing method using a reproducing system having the reproducing apparatus and server device. First, an example of the server device will be explained. FIG. 1 is a block diagram showing an example of a reproducing system according to an embodiment of the invention.

<Server Device According to One Embodiment of the Invention>

In FIG. 1, the reproducing system has a distribution site T, and a receiving terminal device R to which a module having divided contents stored therein is distributed from the distribution site T. The distribution site T has plural server units S1 to Sn, each of the server units S1 to Sn has plural module units M1 to Mm, and each can distribute contents individually. A gateway 12 is connected to the server units S1 to Sn, and at least a license managing unit 11 and an I/F 13 are connected to the gateway 12. The I/F 13 carries out an interface process for communication through a network (an exclusive line such as a content delivery network (CDN) or the Internet). The gateway 12 controls communications, authenticates the user, and distributes contents if authenticating successfully. Further, the license managing unit 11 determines the module distribution procedure in every user requesting distribution, in every terminal, or in every security module owned by the terminal, and produces and manages key information composed of corresponding key combination. If the key information is illegally acquired and distributed, the user, the terminal or the security module owned by the terminal is specified, thereby making it possible to revoke by prohibiting contents distribution or license issuing.

The key information for encrypting and decoding divided contents includes a cipher key and a decoding key. When encrypting by a common key encrypting method, a cipher key is a decoding key. In addition, in the case of a public key encrypting method, a cipher key is not a decoding key, and a secret decoding key corresponding to a cipher key or the like is used.

<Recording and Reproducing Apparatus According to One Embodiment of the Invention>

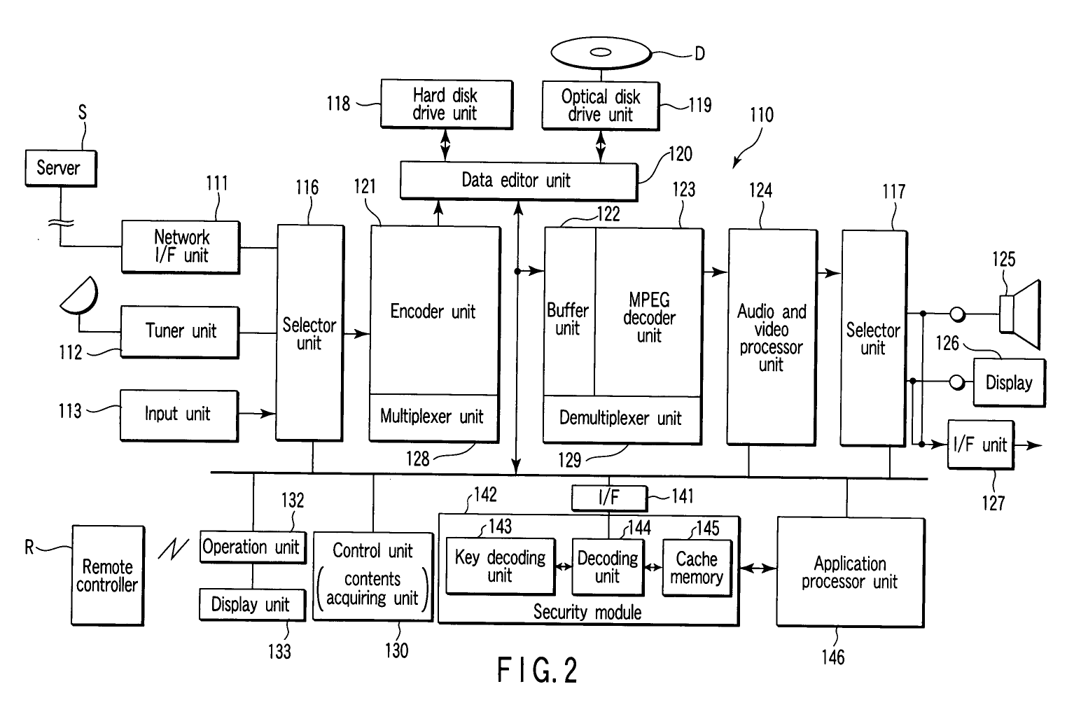

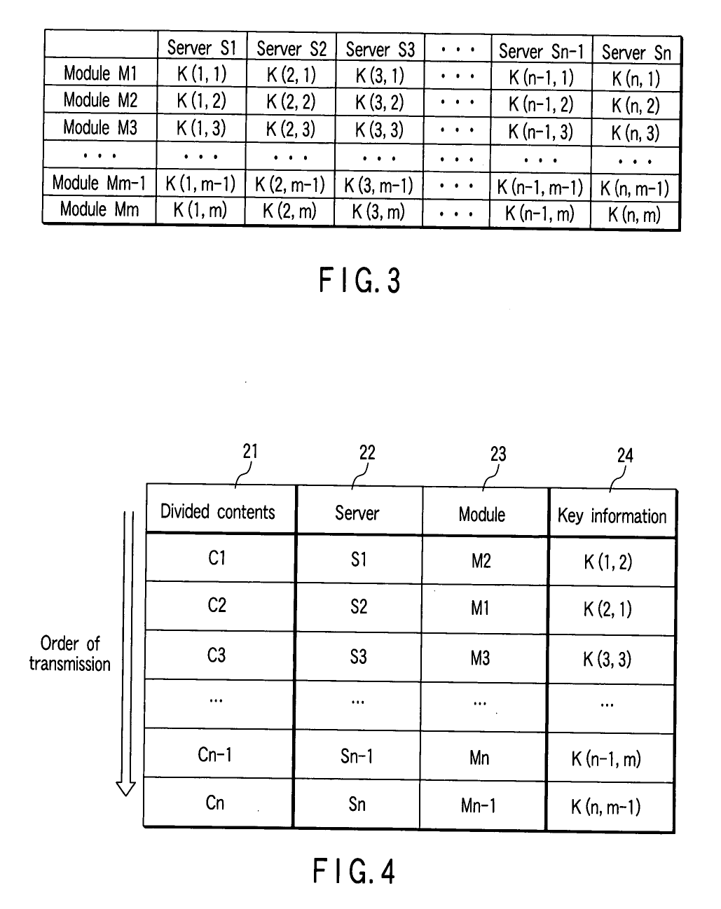

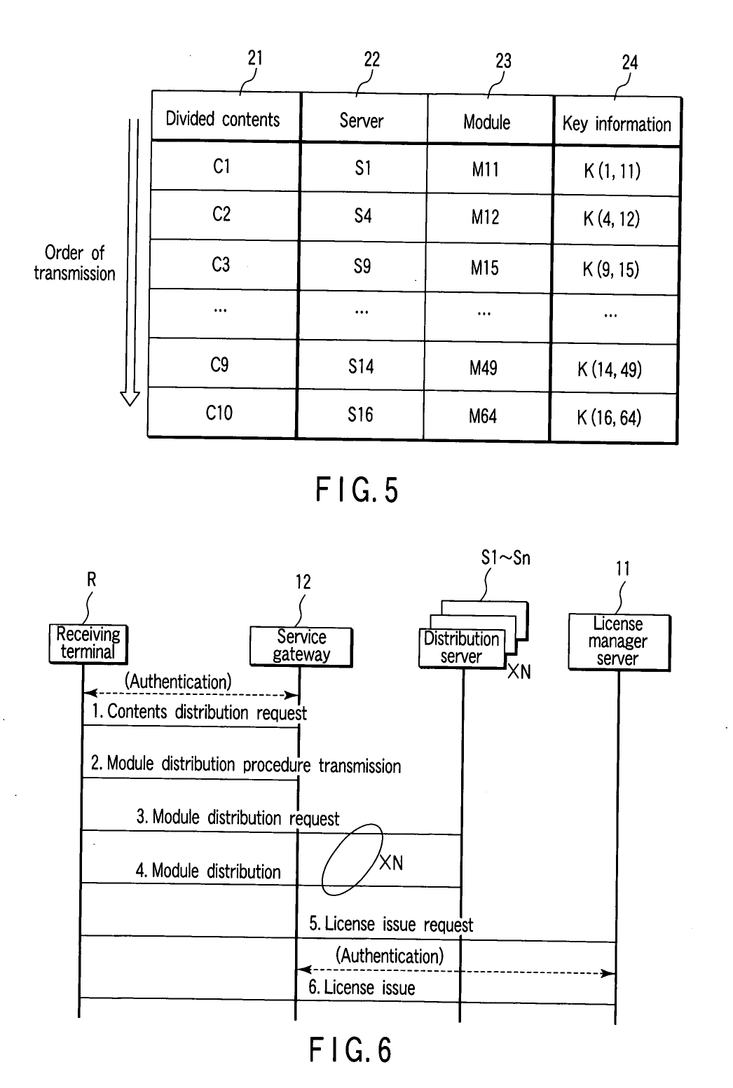

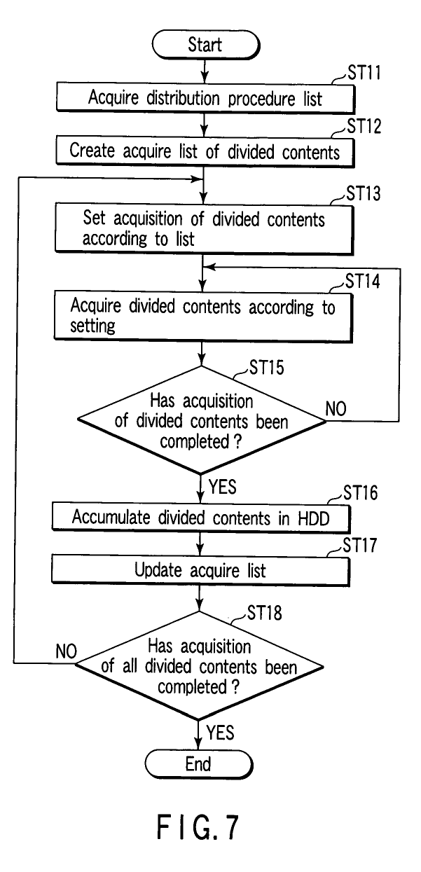

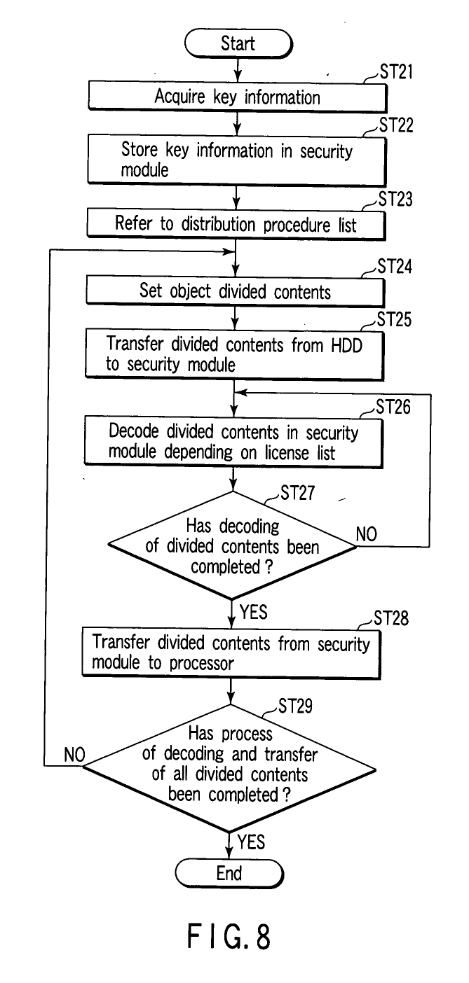

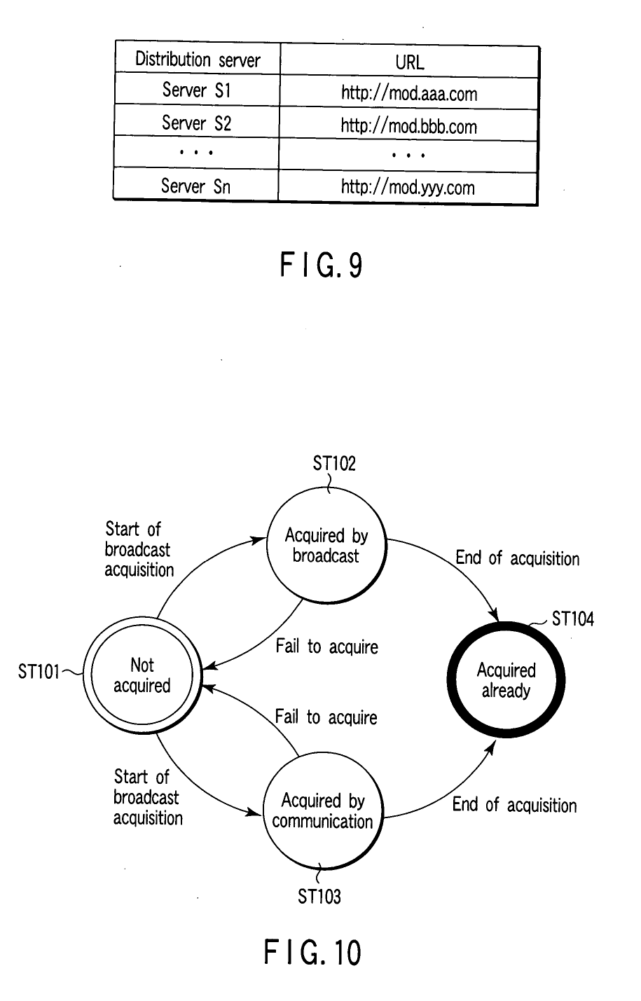

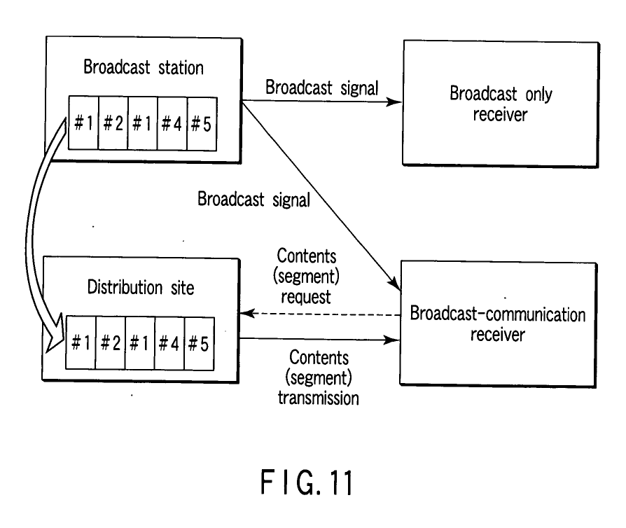

A recording and reproducing apparatus according to the embodiment of the invention will be explained. FIG. 2 is a block diagram showing an example of a configuration of the recording and reproducing apparatus according to the embodiment of the invention, FIG. 3 is a diagram showing correspondence of a server unit, a module unit and plural decoding keys handled by the reproducing system, FIG. 4 is a diagram showing relation among divided contents, a server unit, a module unit, and a key information handled by the reproducing system, FIG. 5 is a diagram showing another relation among the divided contents, server unit, module unit, and key information handled by the reproducing system, FIG. 6 is an explanatory diagram showing an outline of a communication process in reproducing system, FIG. 7 is a flowchart showing an example of a process of acquiring contents in the reproducing apparatus, FIG. 8 is a flowchart showing an example of a process of reproducing contents in the reproducing apparatus, FIG. 9 is a diagram showing addresses of distribution servers to be accessed by the reproducing apparatus, FIG. 10 is an explanatory diagram showing an outline of a method of acquiring contents in the reproducing system, and FIG. 11 is an explanatory diagram showing an outline of a method of acquiring contents in the reproducing system.

The addresses of the distribution servers in FIG. 9 are provided as distribution from the gateway server 12 or license manager server 11.

(Configuration)

In this embodiment, the recording and reproducing apparatus R is shown as an apparatus capable of handling both a DVD-RAM and a hard disk as recording media, but the recording media are not limited thereto, and may preferably include a recording medium by a semiconductor memory or the like. FIG. 2 may be roughly divided into two halves, and the left side shows main blocks of a recording unit, and the right side shows main blocks of a reproducing unit.

The recording and reproducing apparatus R in FIG. 2 has two disk drive units 118 and 119. First, as a first information recording medium capable of building up a video file, an optical disk D is rotated and driven, and the information is read and written by the optical disk drive unit 119. On the other hand, the hard disk drive unit 118 drives a hard disk as a second medium. A control unit 130 is connected to individual units by way of a data bus which manages the entire operation.

The recording and reproducing apparatus R in FIG. 2 mainly comprises an encoder unit 121 for configuring the recording side, an MPEG decoder unit 123 for configuring the reproducing side, and the control unit 130 for controlling the operation of the entire apparatus. The recording and reproducing apparatus R further includes an input side selector 116 and an output side selector 117. The input side selector 116 is connected with a network I/F UNIT 111, a tuner unit 112, and an input unit 113, and issues a signal to the encoder unit 121. The recording and reproducing apparatus R further includes the encoder unit 121, a data editor unit 120 for receiving an output from the encoder unit 121, and carrying out a desired data process such as data editing, the hard disk drive unit 118 and the optical disk drive unit 119 which are connected to the data editor 120. The recording and reproducing apparatus R moreover includes an MPEG decoder for receiving and decoding signals from the hard disk drive unit 118 and the optical disk drive unit 119, the encoder unit 121, a buffer unit 122, the MPEG decoder 123, a multiplexer unit 128, a demultiplexer unit 129 for separating a packet, the control unit (contents acquiring unit) 130, an I/F unit 141, a security module 142, a key decoding unit 143, a decoding unit 144, a cache memory 145, and an application processor unit 146.

These units are connected to the control unit 130 by way of the data bus. Further, the output of selector unit 117 is connected to an external speaker 125 and a display unit 126, or supplied to an external device by way of an interface unit 127 which makes communication with an external device.

The security module 142 is either a built-in IC chip, or a recording medium or IC card detachably connected to the I/F unit 141. Or a PCMCIA card may be used, or a recording medium using a USB terminal may be preferably used. Another medium may be also used preferably.

The recording and reproducing apparatus R also has an operation unit 132 connected to the control unit 130 by way of the data bus, the operation unit receiving user's manipulation or operation of the remote controller R. The remote controller is nearly equivalent in operation to the operation unit 132 provided in the main body of the recording and reproducing apparatus R, and is capable of instructing recording and reproduction of the hard disk drive unit 118 or optical disk drive unit 119, instructing editing, operating the tuner, setting reservation of recording, and setting various factors.

(Operation)

-Recording Process

Operation of the recording and reproducing apparatus having such a configuration will be explained below. First, recording operation will be described specifically including other embodiments. As the input side of the recording and reproducing apparatus, the network I/F unit 111 is connected to the server S or the like via a network (basically an exclusive line such as a content delivery network (CDN) or the Internet), and downloads the contents information. The tuner 112 selects and demodulates a broadcast signal through an antenna, and receives video signal and audio signal. The tuner 112 is applicable to wide range of broadcast signals, including, for example, analog terrestrial broadcast, digital terrestrial broadcast, BS analog broadcast, BS digital broadcast, CS digital broadcast, and others, but not limited thereto. Not limited to one, for example, two or three tuners may be provided for analog terrestrial broadcast, and may be functioned in parallel depending on requests for reservation of recording.

The input unit 113 receives from outside a video signal such as a luminance signal, a color difference signal or composite, and an audio signal. They are inputted and controlled by the selector 116 which is controlled by the control unit 130 or the like, and are selectively supplied into the encoder unit 121. That is, the encoder unit 121 receives the external analog video signal and external analog audio signal from the input unit 130, and the analog video signal and analog audio signal from the TV tuner 112, through the selector 116.

The encoder unit 121 has analog/digital converters for video and for audio which digitize the analog video signal and analog audio signal inputted from the selector 116, a video encoder, and an audio encoder. The encoder unit 121 also includes a sub video encoder. Output of the encoder unit 121 is converted into a predetermined compressed format such as MPEG, and supplied into the control unit 130.

The apparatus in FIG. 2 supplies the information encoded by the encoder unit 121 (a pack of video, audio, sub video data, etc.) and created management information to the hard disk drive unit 118 or optical disk drive unit 119 through the control unit 130, and records in the hard disk drive unit 118 or optical disk D. Information recorded in the hard disk drive unit 118 or optical disk D can be recorded in the optical disk D or hard disk drive unit 118 by way of the control unit 130 and optical disk drive unit 119.

-Editing Process

The data editor 120 edits and processes video objects of plural programs recorded in the hard disk drive unit 118 or optical disk D, by partly deleting, linking objects of different programs, or the like.

At the time of editing process or other process, information to be noticed to the user, out of execution results of an MPU, is displayed in the display unit 133 of the recording and reproducing apparatus, or displayed on OSD (on-screen display) of the display 126. The control unit 130 has the operation unit 132 for giving an operation signal for operating the apparatus. The operation unit 132 is preferably accompanied by the remote controller R.

-Reproducing Process

A process of reproducing recorded information is described specifically including other embodiments. The MPEG decoder 123 has a video processor for synthesizing decoded main video with decoded sub video appropriately, and outputting the main video together with a menu, a highlight button, a sub-title or other sub video.

An output audio signal of the MPEG decoder 123 is converted to an analog signal in a digital/analog converter (not shown) through the selector unit 117, and is supplied to the speaker 125, or supplied to an external device through the I/F unit 127. The selector unit 117 is controlled by a select signal from the control unit 130. Hence, when directly monitoring a digital signal from the TV tuner 112 or input unit 113, the selector unit 117 can directly select a signal skipping the encoder unit 121.

The recording and reproducing apparatus R of the embodiment has such comprehensive functions, and in a wide range of sources, data can be recorded and reproduced in and from the optical disk D or hard disk drive unit 118. Next, the downloading process and reproducing process of divided contents from the distribution site T by the recording and reproducing apparatus R will be specifically described below with reference to the flowchart.

<Contents Acquiring Process and Reproducing Process>

Downloading process and reproducing process for divided contents from distribution site T by the recording and reproducing apparatus R will be specifically described below with reference to the flowchart.

(Contents Acquiring Process)

The recording and reproducing apparatus R acquires the contents in the following procedure by using the network interface unit 111 and security module 142 mainly under the control of the control unit (contents acquiring unit) 130 in the explanatory diagram in FIG. 6 and the flowchart in FIG. 7. First, the recording and reproducing apparatus R accesses the address depending on each of the server units S1 to Sn of the I/F unit 13 of the distribution site T, according to the address as shown in FIG. 9, for example, by way of the network I/F UNIT 111. Preferably, the address should be one for one distribution site T.

At the distribution site T, after receiving the access from the recording and reproducing apparatus R, an authentication process is carried out. When the authentication is successful, the license managing unit 11 determines the own distribution procedure for the user, and generates data of distribution procedure information. If there are 100 users, 100 different combinations of server units and module units are prepared. The distribution procedure information is supplied to the receiving terminal device R via a network (basically CDN or Internet) by way of the I/F 13.

The distribution procedure information (or distribution procedure list hereinafter) is as shown in FIG. 4 or FIG. 5, showing which module 23 corresponds to which server 22 in each one of divided contents 21. It also shows key information 24 corresponding to combination of the server and module. Herein, the key information 24 is shown as function K (1 to m, 1 to n) of the value corresponding to each of the modules M1 to Mm and each of the servers S1 to Sn, but is not always required to be a specific function. Such distribution procedure list and plural pieces of key information are encrypted by a master key corresponding to user's security module 142, and supplied to the recording and reproducing apparatus R via a network (basically CDN or Internet). Difference between FIG. 4 and FIG. 5 is as follows: FIG. 4 shows divided contents are supplied one by one sequentially by plural servers, but such restriction is not particularly present in distribution, and divided contents and plural servers may correspond to each other at random, and such an example is specifically shown in FIG. 5.

The recording and reproducing apparatus R acquires such a distribution procedure list (ST11). Corresponding to this, an acquisition list of divided contents is created (ST12). Corresponding to this list, acquisition of divided contents (modules) is set (ST13). Corresponding to this setting, divided contents are acquired (ST14). Herein, it is determined whether acquisition of divided contents is complete or not (ST15), and if not complete, returning to ST14 in which acquisition of divided contents continues. When acquisition is complete, the acquired divided contents are sequentially accumulated in the hard disk drive unit 118 (ST16). Depending on the acquired divided contents, the acquisition list is updated (ST17). Thus, completion of acquisition of all the divided contents is determined (ST18), and if not complete, returning to ST13 in which acquisition of divided contents continues.

(Contents Reproducing Process)

In the recording and reproducing apparatus R, the procedure of a process of reproducing thus acquired divided contents will be explained specifically below according to the flowchart in FIG. 8. That is, in the recording and reproducing apparatus R, key information is acquired from the distribution site T via a network by way of the network I/F UNIT 111 mainly under the control of the control unit 130 (ST21). The key information is stored in the security module 142 (ST22). Referring to the acquired distribution procedure list (ST23), object divided contents are set (ST24). Corresponding to this setting, the divided contents are transferred from the hard disk drive unit 118 to the security module 142 (ST25).

Corresponding to the distribution procedure list, plural pieces of encrypted key information are decoded in the key decoder 143 by using master keys Km different in each security module 142, and plural pieces of decoded key information are supplied to the decoder 144. In the decoder 144, plural divided contents are decoded depending on the plural pieces of decoded key information and distribution procedure list (ST26).

It is determined whether the process of decoding all the divided contents is complete or not (ST27), and when all are decoded, decoded divided contents are transferred from the security module 142 to the MPEG decoder 123, the packet is divided in the divider 129 and MPEG decoding is processed, and a subsequent reproducing process is executed (ST28).

Herein, divided contents are developed and reorganized in a storage region of a RAM (not shown). The video signal and audio signal are returned to compressed signals and reproduced in the audio and video processor 142. This process continues until decoding process and transfer process for all the divided contents are complete (ST29).

A series of programs is stored in a ROM (not shown) or the like in the control unit 130, and is loaded and started when the power source is turned on. User's setting information and other information required to be stored even after the power is turned off are saved in, for example, a NVRAM (not shown) or the like. Processing of the control unit 130 may also include control of start and stop of reproduction through the remote controller or the like, and display of separately acquired program information.

(Other Acquiring Process and Reproducing Process)

In spite of the description above, for example as shown in FIGS. 10 and 11, the divided contents, distribution procedure list, and plural pieces of key information (bunch of keys) may not be distributed from the distribution site T, but partly or wholly distributed from a broadcast station. That is, in the recording and reproducing apparatus R, preferably, part or whole of the divided contents, distribution procedure list, and plural pieces of key information (bunch of keys) may not acquired from the broadcast station by way of the tuner 112, from the state before acquisition (ST101) (ST102). Or, simultaneously, part or whole of them may be acquired by communication through the network (ST103). Thus, by performing network communication or broadcast communication in parallel, or by employing either, the recording and reproducing apparatus R can acquire the divided contents, distribution procedure list, and plural pieces of key information (bunch of keys) (ST104). Or, by acquiring the divided contents, distribution procedure list, and plural pieces of key information (bunch of keys) as signals superimposed on broadcast signals from the broadcast station through the distribution site T individually, both are acquired separately. Thereby, both are not eavesdropped by a third party, so that the security can be fortified. By the same reason, it is also preferred to transmit the distribution procedure list and plural pieces of key information (bunch of keys) from different sites, or transmit from a same site at different timings.

As described herein, in this embodiment, first, in the server device for distributing contents to the reproducing apparatus, by dividing one content, divided contents are distribute by using any one of plural server units of server device, or any one of plural module units owned by each server unit. At this time, divided contents are sorted in an arbitrary sequence, that is, in a sequence unique for the user, for example, a second module unit of a first server unit, followed by a first module unit of a second server unit, a fourth module unit of a third server unit, a third module unit of a fourth server unit, and so forth. At this time, the sequence unique for the user is distributed as distribution information such as module distribution procedure information, to the user's reproducing apparatus together with divided contents.

At this time, the divided contents are encrypted by a cipher key peculiar to the module unit of the server unit, and plural decoding keys corresponding to the sequence of these original module units are transmitted to the reproducing apparatus together with divided contents.

Herein, the module is a transmission format encrypting divided contents of plain text, and storing in a distribution format such as HTTP or RTP, and the module unit is a place in the server unit for encrypting and generating the transmission format.

In the reproducing apparatus, these divided contents are decoded and reproduced on the basis of the distribution information and plural pieces of key information. As a result, divided contents are distributed from plural module units of plural server units, whereby the communication efficiency can be enhanced while dispersing load of the network, and divided contents cannot be decoded and reproduced unless having plural decoding keys specific to divided contents, so that the contents can be protected. Divided contents are not always required to be downloaded in the reproducing sequence. Divided contents may be downloaded at random, and by reproducing the divided contents in specified sequence on the basis of distribution procedure information showing a reproducing sequence supplied separately from divided contents.

As this invention may be embodied in several forms by those skilled in the art without departing from the spirit of the essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. A reproducing apparatus comprising:
a communication unit which receives distribution of contents from a server device via a network;
a decoding unit which decodes the contents received from the server device on the basis of key information;
a reproducing unit which reproduces the contents decoded in the decoding unit; and
a control unit which, when encrypting and distributing divided contents of the contents from plural module units owned by each of plural server units owned by the server device, controls to: distribute distribution information showing each of the divided contents to be supplied from which one of the plural module units in the plural server units, plural decoding keys depending on each module unit of each server unit, and plural divided contents individually encrypted by the plural decoding keys, from the server device via the communication unit; to decode the plural divided contents by the decoding unit on the basis of the distribution information and the plural decoding keys; and to reproduce the decoded contents by using the reproducing unit.

2. The reproducing apparatus according to claim 1, further comprising:
a tuner unit which receives and demodulates broadcast signals to output video and audio signals, wherein the control unit controls to receive at least one of the distribution information and the plural decoding keys from the tuner unit.

3. The reproducing apparatus according to claim 1, wherein the control unit has the distribution information and plural decoding keys supplied from different devices, or supplied through different interfaces.

4. The reproducing apparatus according to claim 1, wherein the distribution information and plural decoding keys are information peculiar to each user of the reproducing apparatus, and distribution information and plural decoding keys of other users are different in each user.

5. The reproducing apparatus according to claim 1, further comprising:
a detachable card type storage medium having a storage region to store the supplied distribution information and plural decoding keys.

6. The reproducing apparatus according to claim 1, further comprising:
a detachable storage medium which is at least one of a PCMCIA card and a USB input/output module, the storage medium having a storage region to store the distribution information and plural decoding keys.

7. The reproducing apparatus according to claim 1, further comprising:
an IC chip incorporated in the reproducing apparatus, the IC chip having a storage region to store the supplied distribution information and plural decoding keys.

8. A reproducing system composed of a server device and a reproducing apparatus connected to the server device, comprising:
a server device having plural server units each having plural module units; and
a reproducing apparatus having: a communication unit which receives distribution of contents from the server device via a network; a decoding unit which decodes the contents received from the server device on the basis of key information; a reproducing unit which reproduces the contents decoded in the decoding unit; and a control unit which, when encrypting and distributing divided contents of the contents from plural module units owned by each of plural server units owned by the server device, controls to: distribute distribution information showing each one of the divided contents to be supplied from which one of the plural module units in the plural server units, plural decoding keys depending on each module unit of each server unit, and plural divided contents individually encrypted by plural decoding keys corresponding to the plural decoding keys, from the server device via the communication unit; to decode the plural divided contents by the decoding unit on the basis of the distribution information and plural decoding keys; and to reproduce the decoded contents by using the reproducing unit.

9. The reproducing system according to claim 8, wherein the reproducing apparatus further comprises a tuner unit which receives and demodulates broadcast signals to output video and audio signals, and
the control unit controls to receive at least one of the distribution information and plural decoding keys from the tuner unit.

10. The reproducing system according to claim 8, wherein the control unit has the distribution information and plural decoding keys supplied from different devices, or supplied through different interfaces.

11. The reproducing system according to claim 8, wherein the distribution information and the plural decoding keys are information peculiar to each user of the reproducing apparatus, and distribution information and plural decoding keys of other users are different in each user.

12. The reproducing system according to claim 8, wherein the reproducing apparatus further comprises a detachable card type storage medium having a storage region to store the supplied distribution information and plural decoding keys.

13. The reproducing system according to claim 8, wherein the reproducing apparatus further comprises a detachable storage medium which is at least one of a PCMCIA card and a USB input/output module, the storage medium having a storage region to store the supplied distribution information and plural decoding keys.

14. The reproducing system according to claim 8, wherein the reproducing apparatus further comprises an IC chip incorporated in the reproducing apparatus, the IC chip having a storage region to store the supplied distribution information and plural decoding keys.

15. A reproducing method of reproducing contents by using a server device having plural server units each having plural module units, and a reproducing apparatus connected to the server device, the method comprising:
when distributing divided contents of the contents from plural module units owned by each of the plural server units owned by the server device, distributing distribution information showing each one of the divided contents to be supplied from which one of the plural module units in the plural server units, plural decoding keys depending on each module unit of each server unit, and plural divided contents individually encrypted by cipher keys depending on the plural decoding keys, from the server device;
decoding the plural divided contents on the basis of the distribution information and plural decoding keys; and
reproducing the decoded contents.

16. The reproducing method according to claim 15, wherein the reproducing apparatus controls to receive at least one of the distribution information and plural decoding keys from a tuner unit which receives and demodulates broadcast signals to output video and audio signals.

17. The reproducing method according to claim 15, wherein the distribution information and the plural decoding keys are supplied from different devices, or supplied through different interfaces.

18. The reproducing method according to claim 15, wherein the distribution information and plural decoding keys are information peculiar to each user of the reproducing apparatus, and distribution information and plural decoding keys of other users are different in each user.

19. The reproducing method according to claim 15, wherein the reproducing apparatus further comprises a detachable card type storage medium having a storage region to store the supplied distribution information and plural decoding keys.

20. The reproducing method according to claim 15, wherein the reproducing apparatus further comprises a detachable storage medium which is at least one of a PCMCIA card and a USB input/output module, the storage medium having a storage region to store the supplied distribution information and plural decoding keys.
